(19) United States
(12) Patent Application Publication
(10) Pub. No.: US 2002/0095365 A1
(43) Pub. Date: Jul. 18, 2002

(54) Corporate products trading marketplace

(75) Inventors: Fred G. Slavin, Manalapan, NJ (US); Stephan V. Donelian, New York, NY (US); Steven Cohen, Brooklyn, NY (US); Michael Trenk, Scarsdale, NY (US); Judah Kaplan, Teaneck, NJ (US); James E. Lewis, New York, NY (US)

Correspondence Address: OSTROLENK FABER GERB & SOFFEN, 1180 AVENUE OF THE AMERICAS, NEW YORK, NY, 100368403

(73) Assignee: The Chase Manhattan Bank

(21) Appl. No.: 09/760,577

(22) Filed: Jan. 16, 2001

(51) Int. Cl. G06F 17/60

(52) U.S. Cl. 705/37; 705/14; 705/1

(57) ABSTRACT

A company transfers underperforming assets (UPA's) to a second party in return for a cash and/or asset payment. The company obligates itself to earn a variable number of consumption points for an agreed to consumption period by making future purchases of assets. Each purchase has a known number of consumption points associated therewith. The number of consumption points to be earned varies as a function of a periodically applied interest rate. A computerized, preferably web-based, system is used to carry out the foregoing process.

### BACKGROUND OF THE INVENTION

The present invention relates to a process for marketing products and services, and in particular to a process and electronic trading system which permits companies to exchange underperforming assets and promises to earn points by purchasing other products and services for other assets.

In the manufacturing and service sectors, many companies have underperforming assets (“UPA's”) which are typically out of fashion, obsolete, and time sensitive items close to their usage or expiration date whose value in liquidation would be significantly below cost or book value. Examples of UPA's include apparel, machinery, computers, pharmaceuticals, furniture, film, etc. If an asset is overproduced or shows early signs of under-performance, financial accounting rules discourage companies from taking action. Pre-emptive sales or markdowns below book value causes an immediate loss to earnings whereas retention of the asset has no current consequence.

A simple example would be apparel. A designer such as Liz Claiborne may have dresses from last season's inventory with a book value of one million dollars. However, because of the seasonal nature of clothing, and the fact that the styles made this year may not be acceptable in next year's market, the market value of those dresses is probably substantially less than the million dollar book value. A fast and simple solution to this problem is to sell the dresses directly to a large cash buyer, for example, Marshall's. However, because of the need to sell the dresses at a significant discount with a corresponding accounting loss in the current period, this is not the most desirable solution. A large unexpected UPA loss negatively impacts corporate earnings and can hurt a company's stock price.

One solution to this problem is to sell the UPA's to a trading house at book value in exchange for trade credits of equal value. Trade credits are effectively a discount coupon which allows the corporation to purchase products in the future at a discount. A typical coupon may entitle the corporation to a $100 discount on a $1,000 purchase of goods or services from the trading house.

As long as the trading house has goods and/or services which the corporation wants to buy and can sell those goods and/or services to the corporation at a cost which is no more (at least taking into account the trade credits) than the cost that the corporation would pay to purchase those goods or services in the open marketplace, this is an attractive solution for the corporation.

Trading houses generally can achieve this result because they purchase a specific class of goods and/or services in very large volume. For example, some trading houses specialize in purchasing travel services (e.g., airline seats and hotel space) in very large quantities and can obtain significant volume discounts for the services they purchase. A corporation selling UPA's will try to find a trading house who specializes in goods and/or services which that corporation needs and which that corporation may not be able to obtain at a large discount by itself. If a successful match is found between the corporation and the trading house, and if the trading house can continue to sell the goods and/or services required by the corporation at a significant discount, the relationship is a profitable one for both the corporation and the trading house.

A typical transaction with a trading house will be described. A corporation with a left over inventory of blouses with a book value of one million dollars and a fair market value of $500,000 will find a trading house which specializes in a particular product or service which the corporation routinely purchases. For example, if the corporation purchases a large quantity of travel services (airline tickets and hotel rooms), it will find a trading house which is known for purchasing such travel services in large quantities and therefore can sell such services to the corporation at a discount.

In such a case, the company will sell the blouses to the trading house for one million dollars worth of trade credits. Each trade credit will be worth, for example, $10 towards the purchase of a $100 of travel services. The trade credits typically are good for a predetermined period of time, e.g., four years, after which they expire. The trading house can resell the blouses to one or more third parties for their $500,000 fair market value. As long as the trading house is able to obtain travel services at a discount which is at least 10% below the price that a corporation would normally pay for the travel services, the trading house can price the travel services (e.g., hotel rooms) to the corporation at an amount which, with the 10% discount represented by the trade credit companies, is less than the price the company would pay for the travel service if it purchased the service on its own. As long as the corporation gets at least $500,000 of value from these discounts, the transaction will have an economic benefit for the corporation. To the extent that the corporation receives more than $500,000 in value when using the trade credits, it will have earned more than it would have earned had it sold the UPA's directly. As long as the trading house sells its travel services at a profit that is more than $500,000 and the cost of carrying out the various transactions, the trading house will have profited from the transaction.

While the foregoing system is often advantageous to both the corporation and the trading house, it contains various risks. For example, a trading house which obtains very significant discounts in airline services when the UPA is initially sold to it may not be able to obtain those discounts a year or two later. In such a case the trading house cannot sell the travel services to the corporation at a sufficient discount to make it worthwhile for the corporation to use its trade credits and purchase those services from the trading house. Additionally, the corporation is somewhat at the mercy of the trading house since the trading house decides how much of a discount each trade credit will earn the company for the goods or services the trading house offers.

Instead of offering trade credits in exchange for a company's UPA's, some trading houses now offer money in exchange for UPA's along with the company's promise to purchase an agreed to amount of additional goods and/or services (i.e., assets) in the future from the trading house. In this scenario, the trade credit has evolved into a trade obligation to purchase or consume. The degree of the company's future purchase obligations is typically assessed in some measurable way, e.g., points. For example, a company will sell UPA's having a book value of one million dollars to a trading house in return for one million dollars in cash. The company will also make a commitment to earn an agreed to number of points (“consumption points”) by making future purchases from the trading house. The number of consumption points to be earned is negotiated between the seller of the UPA and the trading house at the outset of the deal. Consumption points may be calculated as a function of the difference between the book value and the cash value of the UPA's plus interest. Alternatively, the number of consumption points to be earned may equal the amount of cash paid for the UPA's. The agreed to number of consumption points must be earned over an agreed to period of time (the “consumption period”), e.g., 4 years. Assuming that the book value of the UPA's is one million dollars and the cash value is five hundred thousand dollars, the value of the consumption points to be earned will be typically calculated to equal five hundred thousand dollars plus four years of interest. By way of example, the interest could be compounded at 10% annually so that the total value of the consumption points to be earned will be $732,050. Over the four year consumption period, the company will make purchases from the trading house. Before making the purchase the company is informed how many consumption points will be earned for the purchase. For example, the corporation may purchase $1,000 worth of airline tickets and be awarded 100 consumption points. Assuming that each consumption point has a dollar value of $1, this will effectively be a 10% discount for the company.

As the consumption points are earned, they are applied to offset the balance of the number of points the company is obligated to earn. In the normal case, the company will be expected to have earned sufficient consumption points over the 4 year consumption period to have met the entire $732,050 obligation. In the event the company falls short of this goal, the company must make a cash payment to offset the company's outstanding balance of consumption points. For example, if the corporation has purchased sufficient goods to earn consumption points having a value of $700,000 at the end of the consumption period, it will be obligated to make a payment of $32,050 to the trading house.

In at least one prior art system, a financial institution, such as a bank, finances the underlying transaction between the company and the trading house. In this system, a three-way agreement is entered into between the company, the trading house and the financial institution. The company sells its UPA's to the trading house in return for a cash payment from the bank in the amount of the book value of the UPA's. In return, the company agrees to earn an agreed to number of consumption points by making future purchases of assets from the trading house. The number of consumption points to be earned is equal to the amount of cash given to the company by the bank plus interest over the entire consumption period. Each time the company makes a purchase of assets from the trading house to earn consumption points, a percentage of the sale, equal to the dollar value of the consumption points, is given to the bank.

In the prior art, companies involved in these deals are at a disadvantage because the trading house unilaterally sets a multiplier that is used to calculate the number of consumption points earned by each future purchase a company makes. The number of points a company earns for each future purchase equals the purchase price of the asset divided by the multiplier. As such, the multiplier is, in fact, used to represent a percentage of the purchase price of the asset. For example, if a company buys $300 worth of travel services in an effort to satisfy its obligation to earn consumption points, and the trading house sets the multiplier at 20, the company earns only 15 (300 20) consumption points. In contrast, if the trading house sets the multiplier at 6, the company will earn 50 consumption points. As long as the trading house can set the multiplier at its own discretion, the company is at risk that the multipliers will be set unfairly high and the company will find it difficult, if not impossible, to meet its obligation.

The company is also at risk that the trading house will set the price of its goods and services higher than the company would otherwise pay in the open market. Knowing that trading houses have access to goods and services at deep discounts encourages companies to enter into UPA transactions. However if no restrictions are placed on the trading house, the prices offered by the trading house for these assets may not be competitive and the company will not be able to meet its consumption point obligation.

The company is also at risk because the kinds of assets that trading houses offer may be insufficient to enable the company to satisfy its purchase obligations. For example, a trading house that provides discounts on nails would be of little value to a company requiring travel services. While companies are aware of a trading house's inventory (i.e., the types of goods and/or services provided by the trading house) at the outset, a trading house may lose the ability to offer goods and/or services as originally indicated, and the company is left with no recourse.

To summarize, if the trading house limits its inventory, sets the price of its inventory too high or unfairly applies high multipliers, companies may not be able to satisfy their purchase obligation. Additionally, the full interest for the entire value of the up-front cash payment is applied at the outset of the transaction. That is, the consumption point obligation includes the full four years of interest whether the obligation is satisfied early or late during the four year consumption period. This penalizes early payoff and discourages companies from entering into UPA transactions.

### SUMMARY OF THE INVENTION

A method for permitting a company to sell UPA's comprises:

transferring UPA's from the company to a second party in return for a cash and/or asset payments;

the company obligating itself to earn a variable number of consumption points over an agreed to consumption period by making future purchases of assets, each purchase having a known number of consumption points associated therewith, the number of consumption points to be earned varying as a function of a periodically applied interest rate; and

the company making future purchases of the assets during the consumption period so as to at least partially satisfy the obligation.

The periodically applied interest rate varies, preferably by increasing, over the consumption period. The consumption period is preferably divided into a plurality of sub-periods, the interest rate being constant within any given sub-period but changing from sub-period to sub-period.

The future purchases can be made from the second party or from a third party or both. In a preferred embodiment, the second party is a trading house which sells a limited number of categories of assets. The company and the trading house agree to limits on the price at which the trading house can offer to sell the assets to the company. These limits are preferably related to the amount of money the company will have to pay if it purchased the assets independently of the trading house. The limits may be set at the beginning of the consumption period but may periodically changed during the consumption period. These limits are changed upon receipt of proof from the company of its ability to purchase one or more of the assets independently of the trading house at prices which are different than those originally agreed to.

The trading house sets the number of points associated with the sale of each asset. However, the trading house and the company preferably agree to minimum limits on the number of points the trading house will offer to award the company in connection with each sale of an asset. The minimum limits are preferably expressed as a percentage of the price of each asset offered for sale to the company by the trading house. The minimum limits are preferably calculated as a function of the average percentage price for each asset offered for sale to the company by the trading house or in terms of a respective minimum limit for each category of assets offered for sale to the company by the trading house.

In the preferred embodiment, the company has the option of making cash payments during the consumption period, but prior to the end of the consumption period, to partially satisfy the obligation.

Insurance is preferably obtained to protect the company in the event that the trading house fails to meet its obligation to offer assets to the company at the agreed to price or to award the agreed to minimum number of consumption points in connection with each sale. For example, a trading house may go out of business or otherwise be unable to offer assets that the company can use. The insurance policy protects the company and guarantees performance by the trading house.

In the preferred embodiment, the cash payment is made by a financial institution which receives a percentage of each sale of assets made by the company in fulfilling its obligation to earn consumption points. The payment to the financial institution is preferably a function of the number of consumption points earned in connection with the sale in question.

The foregoing method is preferably carried out utilizing an electronic marketplace which enables companies to enter into deals for the sales of their UPA's. Each deal includes the sale of the UPA by the company, a cash and/or asset payment to the company, and an obligation on the part of the company to purchase future assets to fulfill an agreed to consumption point obligation. The system comprises:

a marketplace administration system connected to a communication network;

a plurality of user terminals connected to said communication network whereby a plurality of companies and one or more UPA buyers can communicate with said marketplace administration system over said communication network;

said marketplace administration system presenting a plurality of trading sites to at least some users of said user terminals, said user sites including:

one or more UPA trading sites at which said companies can offer to sell their UPA's to one or more of said UPA buyers, whereby deals can be entered into between said companies and said UPA buyers and relevant parameters of said deals can be entered into said market administration system; and

one or more sales sites at which said companies can purchase said assets, said sales sites providing an indication of both the price of each said asset and the number of consumption points to be awarded upon the purchase of each said asset;

said marketplace administration system keeping track of said deals and said outstanding balance of consumption points for each said deal.

The communication network is preferably a world wide communication network such as the Internet and the sales sites are preferably web sites. The user sites preferably include one or more sales sites at which UPA's purchased by one or more of the UPA buyers can be resold to third parties. At least one of the UPA sales sites preferably offers UPA's purchased by more than one of the UPA buyers. The UPA's sold on the sales site may be sold by an auctioning system. The potential purchasers of the UPA's are preferably restricted as a function of the identity of the potential purchasers, a class that the potential purchasers fall into or a geographic location in which the potential purchasers are located.

### BRIEF DESCRIPTION OF THE DRAWING(S)

For the purpose of illustrating the invention, there is shown in the drawings several embodiments which are presently preferred, it being understood, however that the invention is not limited to the precise arrangements and instrumentalities shown.

FIG. 1 is a schematic diagram used to explain a process for selling UPA's in accordance with a preferred embodiment of the present invention.

FIG. 2 is a flow diagram showing a preferred procedure for determining the consumption point balance owed by a company selling UPA's in accordance with the present invention.

FIG. 3 is a schematic diagram illustrating an electronic corporate products trading marketplace in accordance with a preferred embodiment of the present invention.

FIG. 4 is a more detailed schematic diagram illustrating how the electronic corporate products trading marketplace of FIG. 3 can be implemented in a further preferred embodiment.

FIGS. 5-8 are web pages showing an exemplary method for the company to purchase assets to fulfill its obligation to earn consumption points.

### DETAILED DESCRIPTION OF EMBODIMENTS OF THE INVENTION

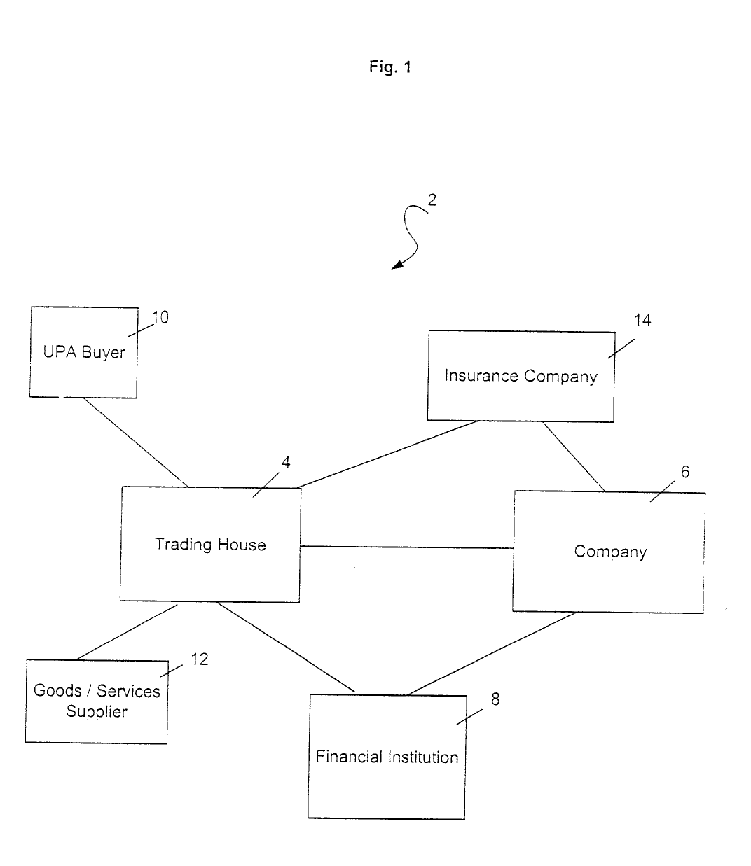

Referring now to the drawings where like numerals indicate like elements, there is shown in FIG. 1 a schematic diagram illustrating the parties to a sale conducted according to the principles of the present invention and helpful in explaining the processes carried out.

The primary participants are a trading house 4, a company 6 and a financial institution 8. These entities enter into a three-way agreement in which the company sells UPA's to the trading house 4, the financial institution 8 makes an agreed to cash payment to the company (preferably having a value equal to the book value of the UPA), the company 6 promises that it will purchase sufficient assets from trading house 4 to earn an agreed to number of consumption points over an agreed to consumption period, the trading house agrees to pay a percentage of each such purchase to the financial institution 8 (so that the financial institution 8 is paid back for the money it pays to the corporation with interest) and the corporation agrees that if there is any balance of consumption points which have been unearned at the end of the consumption period, it will make a payment to the financial institution 8 of an amount equal to the short fall.

At the beginning of the transaction, the parties will typically negotiate at least the following variables:

1. The amount of cash and/or other assets which will be given to the company in return for its UPA's.

2. The number of consumption points which the company agrees to earn over the consumption period.

3. The length of the consumption period.

4. The interest terms (e.g., interest rate and frequency of compounding) to be applied to the outstanding balance of unearned consumption points.

5. Any transaction fees to be paid to the financial institution.

6. Limitations to be placed on the multipliers which can be applied by the trading house to the assets purchased by the company.

7. Maximum amounts that the trading house can charge for various categories of assets.

When negotiating those variables, the parties will look at various factors including the fair market value of the UPA's being transferred to the trading house, the ability of the trading house to sell those assets, the credit history of the company, the purchasing history of the company, etc.

Once the parties have agreed to the terms of the contract, the company 6 will transfer its UPA's to trading house 4 who will in turn sell them to a UPA buyer 10. This can be done in various ways. One way is to make a single sale of the UPA's to a large UPA buyer 10. While this has the advantage of disposing of the entire inventory of UPA's in a single transaction, it does not necessarily maximize the amount of money the trading house 4 receives for the UPA's. Alternatively, the trading house 4 can sell the UPA's to a plurality of buyers or more preferably, place the UPA's on a trading site over the Internet in which a large number of UPA buyers 10 can purchase portions or all of the UPA's.

This latter method has several advantages. Initially, because there will be a large number of potential buyers for the UPA's, it is likely that the price received for the UPA's will be greater than that received if sold to a single UPA buyer 10. Additionally, certain products which might be undervalued in the United States, may still have significant value overseas. This is especially true with fashion where fashion trends tend to vary somewhat from geographical area to geographical area. By placing these products on the Internet, they may be easily sold in remote geographic areas where they are in style and will command a higher price.

When the company transfers its UPA's to the trading house 4 it receives a cash payment from financial institution 8 in the amount negotiated. In a typical case, the cash payment will be equal to the book value of the UPA's. Alternatively, and at the company's request, the financial institution 8 can provide some or all of that cash payment to the trading house 4 (or a third party) in return for the trading house 4 (or third party) providing specified assets to the company 6 of equal value. The financial institution 8 may also receive an up-front transactional fee from the company 6 and/or the trading house 4 for its agreement to finance the transaction.

After the initial exchange of the UPA's and cash (and/or assets), the company 6 must fulfill its obligation to earn the negotiated number of consumption points over the negotiated consumption period by purchasing additional assets from trading house 4. In order to offer sufficient assets to the corporation, the trading house 4 will either purchase goods and/or services from various suppliers 12 and offer them to the company 6 or, alternatively, will merely act as an agent for selling the goods and/or services of the supplier(s) 12. In each case, the specific goods or services will be offered to the company 6 at a stated price and the company 6 will be informed of the number of consumption points that it will earn upon purchase of the goods and services in question.

For purposes of simplicity, it will be assumed in the following examples that the financial institution 8, the company 6 and the trading house 4 agree that each consumption point will be worth $1.00. However, any fraction or multiple of one dollar (or other currency) may be used. Indeed, the obligation to earn consumption points can be expressed in dollars (e.g., $500,000.00) and the points earned can be expressed as either a percentage of the purchase (e.g., 5% of $1,000 purchase) or in multiples (e.g., 20) by which the purchase price is divided. Any other scheme can be employed as long as the effect is substantially the same as the foregoing examples.

In order to enable company 6 to meet this obligation, trading house 4 must offer assets to company 6 at competitive prices. It must also award a number of consumption points for each purchase. For example, the trading house 4 will offer to sell round trip airline tickets from New York to Los Angeles for $400 and to award 40 consumption points for that sale. If the company 6 purchases the round trip ticket, it will make a $400 cash payment, with $360 going to the trading house 4 and $40 going to the financial institution 8. The payment may be made entirely to the trading house 4 which will then, in turn, pay the financial institution 8 its share. Or, the payment may be made by the company 6 directly to both parties. Alternatively, payment may be made in any way so that the trading house 4 and financial institution 8 receive correct amounts of money. The net result of this transaction is that the trading house will have received $360 for the round trip airline tickets, the financial institution 8 will have received $40 and the company 6 will have received its airline tickets. The trading house 4 will make money on the transaction if it was able to purchase the round trip airline tickets from supplier 12 for less than $360.

The number of consumption points awarded for the transaction is conceptually determined as a function of a multiplier representing the effective discount trading house 4 applies to its sale of the asset in question. In this sense, the granting of consumption points is similar to the application of a trade credit. The amount of consumption points which can be awarded by the trading house 4 is determined, in a large part, by the price it must pay for the asset in question from the supplier 12.

If the trading house 4 does a good job of purchasing assets from supplier(s) 12 at large discounts, it can easily offer assets to company 6 at competitive prices and can at the same time grant substantial consumption points for the purchase of that asset. However, both the company 6 and the financial institution 8 are at risk if the trading house 4 fails to offer assets at competitive prices or to grant sufficient consumption points for each asset purchase.

In order to minimize that risk, the preferred embodiment of the present invention places limitations on both the prices at which the trading house 4 can sell its assets and the minimum number of consumption points (preferably based on a percentage of the selling price) it must award for each sale of an asset.

To this end, the trading house 4 will offer to sell items from agreed to categories of assets (e.g., desks and travel services) at a price which is at least as good as the price company 6 can obtain the asset on the open market. These prices may be agreed to at the outset of the transaction and may be revised during the consumption period if the company 6 provides proof of changes of those prices during the consumption period, or if the price trading house 4 pays to acquire the assets from supplier 12 increases.

The trading house 4, the company 6 and financial institution 8 will also agree to a minimum number of consumption points which must be awarded for each sale. This will typically be done as a function of a multiplier, the inverse of which determines the percentage of any given asset sale which must be returned to the financial institution 8 and for which a corresponding number of consumption points are awarded to the company 6.

There are several ways to limit the multiplier that can be used by the trading house. One is to set a predetermined multiplier for each type of asset sold (e.g., a multiplier of 5 for airlines services, a multiplier of for hotel services and a multiplier of 15 for desks). Alternatively, the parties could agree to an average multiplier for all assets offered or for all assets sold to company 6.

As indicated above, company 6 agrees to earn the agreed to number of consumption points during the consumption. If there is any outstanding balance of consumption points at the end of the consumption period, the company 6 agrees to pay financial institution 8 an amount equal to the dollar value of the unearned consumption point balance. A penalty can also be added. For this reason, company 6 is at risk if trading house 4 does not meet its obligations to supply sufficient products, at competitive prices to company 6. If desired, company 6 can obtain an insurance policy to guarantee the trading house's 4 performance. The company 6 is the insured party, the trading house 4 pays the premiums on the policy and guarantees performance. Performance can be guaranteed in various ways. One possibility is for the insurance company to insure the company 6 that the trading house 4 will offer goods and services to the company 6 at the agreed to price (e.g., at the price the company 6 could obtain those goods on the open market). As an adjunct or alternative, the insurance company 14 can simply agree to pay the company 6 the value of any outstanding consumption point obligation at the end of the consumption period in the event that the company 6 is unable to fulfill its obligations due to the failure of the trading house 4 to perform.

It is in the interest of both the trading house 4 and the financial institution 8 for the consumption point balance to be paid back as soon as possible. The trading house 4 wants to sell as many assets as possible to the company 6 in a short time period as possible. Financial institutions do not like to carry risk and want to be paid back the consumption points as soon as possible.

In order to encourage the company 6 to make as many purchases in as short a time as possible, the number of consumption points owed by the company 6 (the consumption point balance) preferably increases over time as a function of agreed to interest terms. This can be done on any periodic basis in any manner desired. For example, the balance of consumption points may be increased every month at an agreed to interest rate (e.g., 1 percent). Since the company 6 will be earning consumption points by making purchases, the consumption point balance will be reduced over time. Since the interest rate is only applied to the balance of consumption points owed, the company 6 will be required to earn fewer consumption points if it reduces its consumption point obligation quickly. This innovation provides an incentive to the company 6 to earn its balance of consumption points quickly to avoid paying interest and avoids a penalty for early payoff.

To further encourage the company 6 to purchase products quickly, the percentage rate preferably increases over time. For example, during the first six months of the redemption period, the consumption point balance will be increased by 1 percent per month, during the following six month period it will be increased by 1¼ percent month, during the following six month period by 1½ percent per month, etc. Whether a constant or variable interest rate is used, the rate can vary from deal to deal based on various factors including the company's credit rating.

As noted above, the company 6 normally pays off its consumption point balance by purchasing goods and/or services. In the preferred embodiment, the company is also provided with the option for paying a cash amount in lieu of earning consumption points. For example, the company 6 can be given the option of purchasing consumption points at $1.00 per consumption point. Thus, the company can reduce or pay off its obligation to the financial institution 8 at any time within the redemption period.

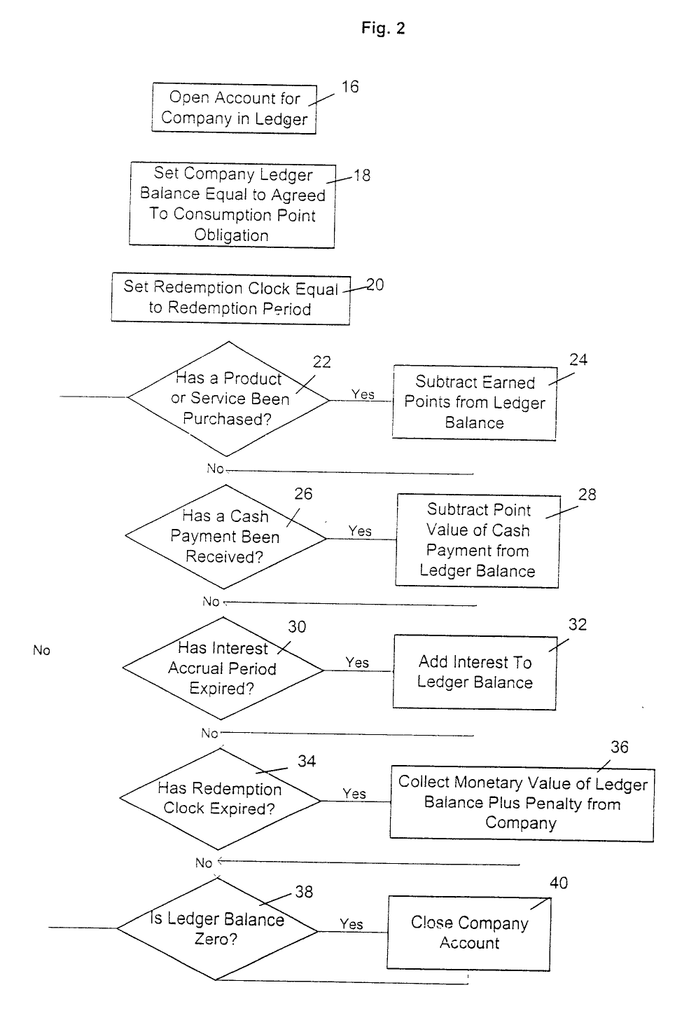

A flow chart of the foregoing process is shown in FIG. 2. In this process, a ledger account system maintains a ledger balance for each company 6 with an outstanding consumption point balance. To this end, a new ledger account is preferably opened each time a company 6 sells a new set of UPA's (step 16). As shown in step 18, the ledger balance in that account is initially set to be equal to the consumption point balance agreed to at the outset of the transaction.

In step 20, a redemption period clock, corresponding to the agreed to redemption period, is initiated. For example, if the redemption period is two years, the redemption clock will initially be set at two years and will count down on a daily basis until it expires.

At step 22, a determination is made as to whether products or services have been purchased from the trading house 4. If they have, the number of consumption points earned as a result of the purchase are subtracted from the ledger balance (step 24).

When no product or service has been purchased, or if a product or service has been purchased and the consumption points have been subtracted from the ledger balance, a determination is made as to whether a cash payment has been received from the company 6 as partial or total payment of the consumption point balance (step 26). If it has, the point value corresponding to the cash payment is subtracted from the ledger balance (step 28).

If no cash payment has been received, or if one has been received and the corresponding number of consumption points have been subtracted from the ledger balance 30, a determination is made as to whether the interest accrual period has expired. The interest accrual period can be any desired period, typically monthly or quarterly. If it has expired, interest is added to the ledger balance (step 32).

The interest added to the ledger balance can be constant or variable. If constant, a preset percentage, e.g., 1% per month, is added to the ledger balance at the end of each accrual period. In order to further encourage the purchase of products from the trading house 4, it is preferred that the interest rate increase over time. For example, a 1% interest rate can be applied for each month during the first 6 months of the consumption period, 1¼% can be added during each months of the second 6 months, 1½% during the third 6 months, etc.

If the interest accrual period has not expired or, alternatively, if it has and interest has been added to the ledger balance, a determination is made as to whether the consumption period has expired (step 34). If it has, the company 6 has failed to meet its obligation within the consumption period and must now make a monetary payment to the financial institution 8 equal to the monetary value of the ledger balance. In the preferred embodiment, a penalty will also be paid by the company 6. Payment of the outstanding balance (plus penalty) can be made in any suitable manner.

If the redemption period has not expired, a determination is made as to whether the ledger balance is zero (step 28). If it is, the ledger account of the company 6 is closed (step 40). If not, the process returns to step 48 and once again determines if any product or service has been purchased.

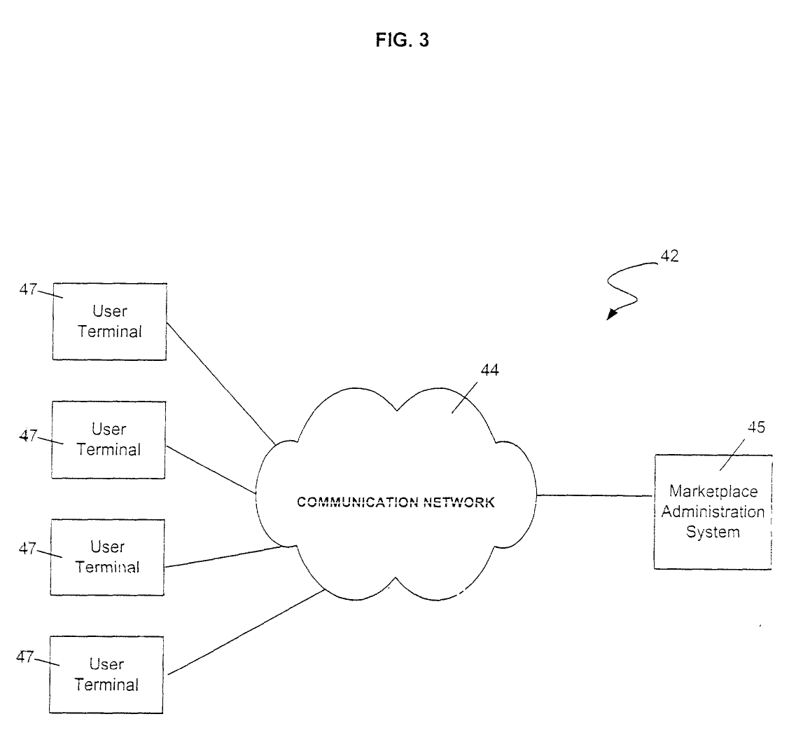

In the foregoing embodiment of the invention, the various transactions presumably take place manually (with the exception of the ledger balance calculator) and through one-on-one negotiations. However, significant advantages can be achieved utilizing an electronic corporate products trading marketplace 42 shown in FIG. 3. The electronic marketplace 42 includes a marketplace administration system 45 which communicates with a plurality of user terminals 47 over a communication network 44, preferably a global communication network, such as the Internet. Electronic marketplace 42 preferably permits, inter alia, a plurality of corporations 6, a plurality of trading houses 4 and one or more financial institutions 8 to communicate with marketplace administration system 45, and if desired with each other, over the communication network 44 utilizing the user terminals 47. The user terminals 47 will typically be personal computers, although any other communication device (e.g., cell phones, PDA's, or any other suitable communication device) can be used. While only four user terminals are shown, the actual number of user terminals will be determined by the number of participants in the electronic trading marketplace 42.

As will be described below, companies can advantageously manage their entire UPA cycle and employ all of the characteristics of the present invention (described above) over the electronic trading marketplace 42. By availing themselves of electronic trading sites, companies 6, trading houses 4 and financial institutions 8 can increase the volume of UPA's exchanged as well as assets sold to increase opportunities and advantages for all parties.

The marketplace administration system 45 administers various functions of the electronic marketplace 42 described below. It preferably provides one or more web sites at which companies 6, trading houses 4 and financial institutions 8 can negotiate UPA deals, one or more web sites at which companies can purchase assets to earn consumption points, and one or more web sites at which UPA's purchased by the trading houses 4 can be resold to third parties. The marketplace administration system 45 also maintains various information concerning the deals entered into between the companies 6, the trading houses 4 and the financial institutions 8 and keeps track of the purchases made by the companies 6 to reduce the companies outstanding balance of consumption points. The marketplace administration system 45 consists of one or more servers (located at a single location or distributed anywhere in the world) which carry out the foregoing functions.

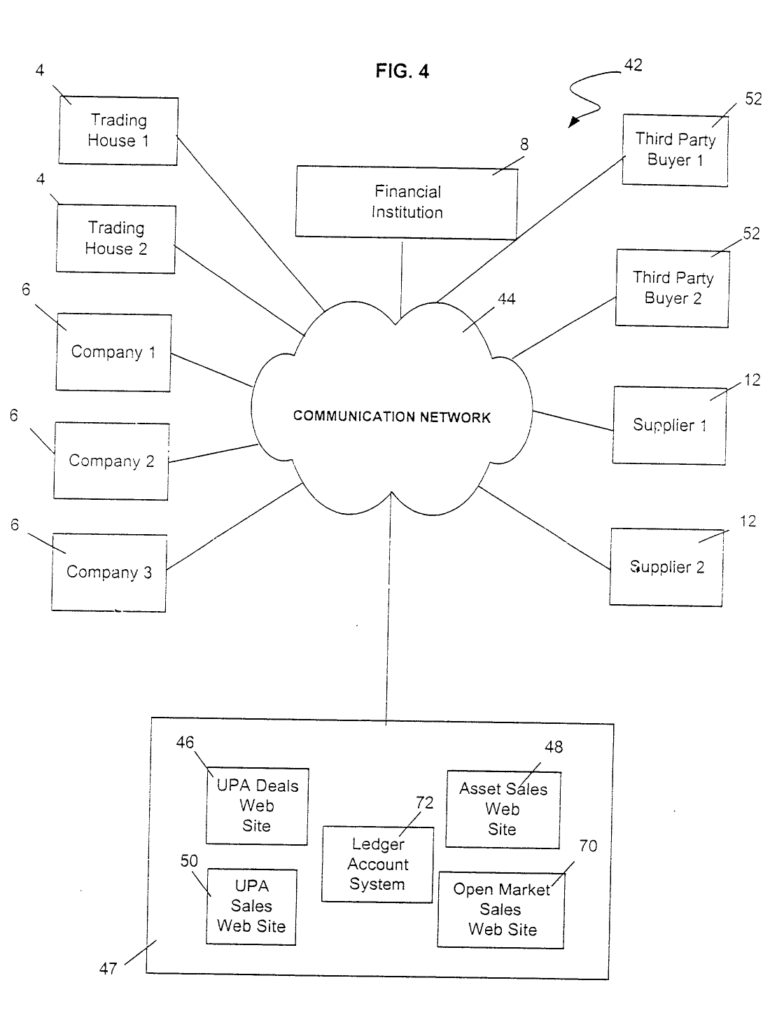

One possible embodiment of the electronic marketplace 42 is illustrated in FIG. 4. In this embodiment, a plurality of trading houses 4, a plurality of companies 6 and one or more financial institutions 8 are connected to the communication network 44, each through a respective set of user terminals 47, and communicate with the marketplace administration system 45 (and, if desired, with each other) via the communication network 44. In the embodiment shown in FIG. 4, there are two trading houses 4, three companies 6 and one financial institution 8. However, it is preferred that there be a large number of companies 6, trading houses 4, and preferably more than one financial institution 8, which can negotiate with one another to enter into various deals for the sales of UPA's.

The marketplace administration system 42 preferably provides, inter alia, a UPA Deals web site 46, an Asset sales web site 48, a UPA Sales web site 50, an open market sales web site 70, and a ledger account system 72. The functions of these various web sites and the ledger account system are described below.

The process of entering into a deal begins when a company 6 offers to sell its UPA's on UPA Deals web site 46. Each company 6 can provide various levels of detail concerning the UPA's it has to offer as well as the cash payment it would like to receive for the UPA's. A plurality of trading houses 4 have access to UPA Deals web site 46 and to the UPA's offered by these companies. A negotiation process can then take place, preferably via the UPA Deals web site 18, in which the financial institution 8, the relevant trading houses 4 and the relevant company 6 negotiate the various terms of the deal including, e.g., the amount of money to be paid to the company 6 in exchange for its UPA's, the amount of consumption points to be earned by the company 6, the consumption period in which to earn them, the interest terms, etc.

In order to assist in the negotiation process, it is preferable to require any company 6 who wishes to participate in the electronic corporate marketplace 42 to register with the marketplace administrative system 45 before they offer any UPA's for sale. During this registration process, the company 6 provides various information which the trading houses 4 and financial institution(s) 8 can consider when determining the various parameters of any deal offered to the company 6. This information can include, for example the name, address, federal tax identification number and credit rating of the company.

The negotiating process can be carried out electronically on web site 46 in any desired manner (e.g., e-mail, chat room, video conference, etc.). Alternatively, web site 46 may merely provide information concerning parties to potential deals and the negotiations for the deals can take place outside of corporate marketplace network 42 as long as at the end of the process, the relevant parameters of the deal are entered into the marketplace administration system 45.

Once a deal has been agreed to, an appropriate contract is issued and signed by the relevant parties. This can be done manually or on-line using any appropriate system. Relevant information relating to the deal (e.g., the number of consumption points at the outset of the consumption period, the length of the consumption period and the interest terms) are sent to the marketplace administration system 45, for example by making appropriate entries in the UPA deals web site 46 and transmitting that information to the marketplace administration system 45 over the communication network 44. This information is stored in one or more memories (not shown) associated with marketplace administration system 45 for later use thereby.

After the contract has been signed, the company 6 will transfer its UPA's to the appropriate trading house(s) 4 and the financial institution 8 will make the agreed to monetary payment to the company 6. The trading house(s) 4 can then place the UPA's on the UPA sales web site 50 for resale to third parties. Various third party buyers 52 can then access the UPA sales web site 50 via the communication network 44 to purchase all or part of the UPA's. This can be done in various ways. The UPA's may be offered for a sale at a specified price and third party buyers 52 have the option of purchasing varying quantities of the UPA's at that price. Alternatively, the UPA's sold on web site 50 can be auctioned in any known manner or one-on-one negotiations can take place.

Since UPA's from various companies purchased by one or more trading houses 4 will be placed on the UPA Sales web site 50, the number and categories of UPA's offered for sale should be quite diverse. This will make UPA Sales web site 50 more attractive to buyers 52 thereby increasing the competitiveness at which the UPA's are sold and ultimately increasing the returns for the trading house 4.

Some companies, for example Liz Claiborne, may not wish their UPA's to be sold on the open market UPA Sales web site 50. Selling designer's fashions, such as Liz Claiborne's, at deep discounts can negatively impact the market. For this reason, they may not want their products offered on UPA Sales web site 50. Alternatively, Liz Claiborne may contractually agree with the trading house 4 to place restrictions on the sale of the UPA's. For example, it may require that UPA's may only be offered for sale in certain geographical regions of the world or to certain specified customers. For this reason and others, UPA sales web site 50 will be restricted, e.g., by user name and password, to enable the system to effectuate the required restriction.

Once the UPA's have been transferred from the company 6 to the trading house 4, the company 6 must then fulfill its obligation to earn consumption points by purchasing assets on the Asset sales website 48. Preferably, a separate Asset sales website 48 is provided for each trading house 4. However, two or more trading houses can agree to share a single Asset sales website 48. While this has the disadvantage of placing the trading houses in competition with one another for the sale of assets, it provides additional security to the companies 6 by insuring the likelihood that it would be able to fulfill its obligation to earn consumption points within the consumption period. Ultimately, this should make the electronic corporate products marketplace 42 more attractive to companies and thereby increase the business of all of the trading houses 4.

One simple example of the manner in which assets can be purchases on sales web site 40 is shown in FIGS. 47. By way of example, but not limitation, the purchasing process is started by entering a first web page shown in FIG. 4 which presents a listing the categories of products and services being offered.

Asset Choice Display Screen 54 contains options for categories 56 and asset types 58. Examples of categories 56 include paper products, writing instruments, storage containers, furniture, technology, and travel. Any number of desired categories of assets (whether products or services) can be included. The user navigates asset choice display screen 54 to locate and select a specific category of asset that he or she wishes to obtain and then selects asset type 58 corresponding to selected category 56.

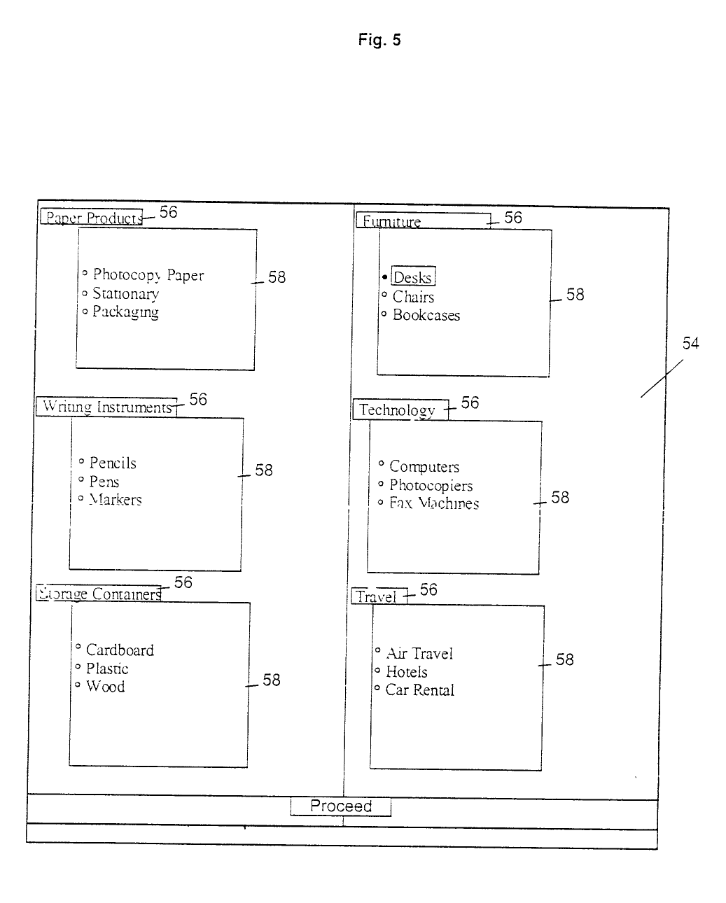

For example, a company can select furniture from category 56, and navigate asset type 58 to select desks. The company 6 is then presented with a display screen such as that shown in FIG. 5.

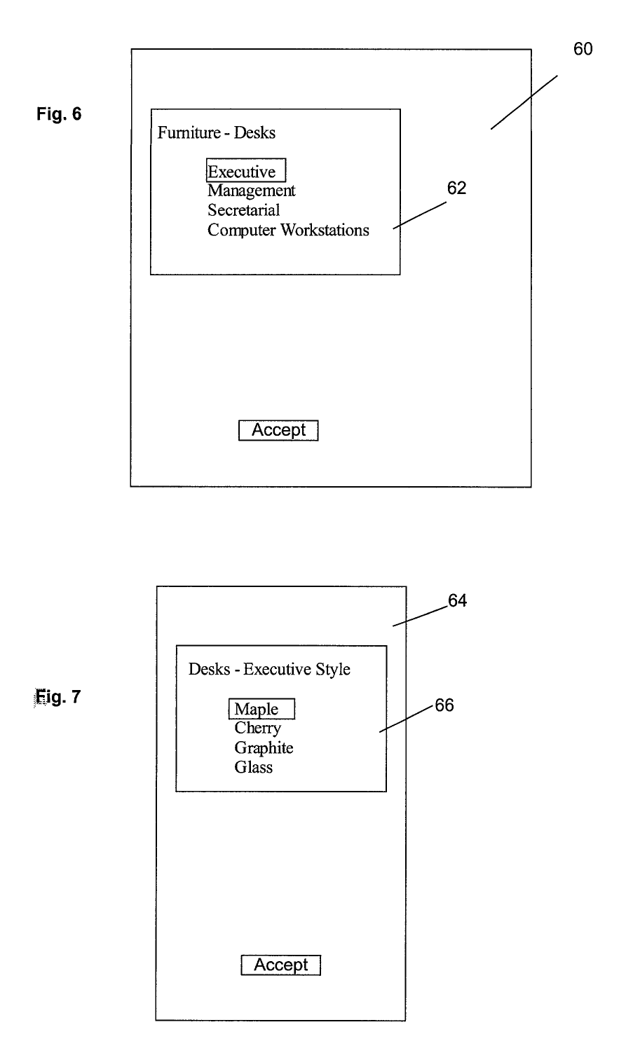

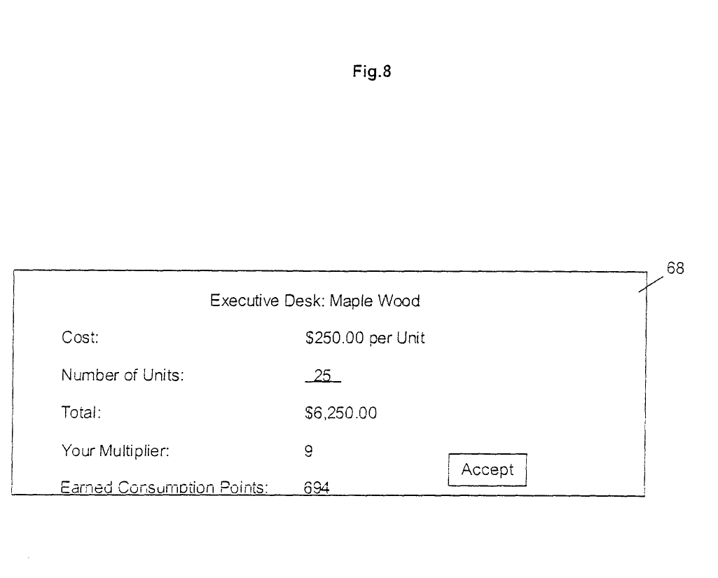

FIG. 4 shows an example of Asset Models Display Screen 60 which displays a list of asset types 62 in this case, office desks, which enables the company 6 to make selections. The user preferably selects a desired choice, e.g., executive desks, in any appropriate manner such as clicking on a designated portion of the screen. The user is preferably presented with the next user Asset Models Display Screen 66, substantially as shown in FIG. 6.

FIG. 6 shows an example of Asset Models Display Screen 64 showing the asset types offered by the trading house 4. To review, order and/or purchase the product, the user preferably clicks on a designated portion of the windowed screen, for example Accept Button. The user is preferably presented with Asset List Display Screen 68 substantially as shown in FIG. 7.

Asset List Display Screen 68 shows the cost per unit of the executive desk, and the multiplier which will be applied to the purchase. The company 6 will then enter the number of units it wishes to purchase (25 in the example shown). The system will then display the total price ($6,250) required to purchase the 25 desks and also indicates both the multiplier applied to the purchase and the number of consumption points which would be earned if the purchase is accepted. If the company wishes to go forward with this purchase, it accepts the purchase by preferably clicking a designated portion of the display screen, for example Accept button. By accepting the offer, the company has purchased the 25 desks, and makes a payment in the amount of $6,250 to the trading house 4. The trading house 4 in turn will make a payment of $694 (assuming that each consumption point is worth $1) to the financial institution 8 and the financial institution will reduce the consumption point balance of company 6 by 694 points.

In the preferred embodiment, an Open Market Sales web site 70 (FIG. 3) is provided wherein independent suppliers offer goods and services which the trading house 4 may be unable to offer. For example, if the trading house 4 does not offer goods and/or services which are desired by company 6, company 6 may be able to locate goods and/or services it needs on the Open Markets Sales web site 70. Preferably the vendors selling these assets are required to award consumption points in connection with these sales (and make corresponding payments to financial institution 8). To prevent direct competition with the trading house 4, goods or services which the trading house can offer will preferably not be available at the same discounted price and point combination on the Open Market Sales web site 70. Additionally, it is preferred that only companies that have entered into UPA agreements with trading houses will be able to access the Asset sales website 48 to purchase discounted goods and/or services. The Asset sales website 48 and Open Market Sales web site 70 will be restricted by some mechanism, e.g., user name and password, wherein services and goods will be offered to appropriate parties at contractually agreed to rates.

In the preferred embodiment, the web sites 26, 48, 50 and 70 are shown as being separate web sites. However, they can be combined into a single web site. Alternatively, each of the web sites 46, 48, 50 and 70 may themselves be formed from a plurality of web sites.

In the preferred embodiment, the trading houses 4, the companies 6, suppliers 12, UPA Deals web site 50, sales web site 20 and financial institution 8 are all connected together electronically. However, any other forms of communication between the various entities in the electronic corporate products trading market place 42 can be used. For example, companies 6 can be provided with catalogs corresponding to the products and services sold on Asset sales website 48 and can send in orders by mail, by phone, etc. Similarly, live retail locations can be used in lieu of, or in addition to the Asset sales website 48. In such a case, information concerning the sale must be sent to marketplace administration system 45.

In the foregoing embodiments, a single financial institution 8 is shown. However, a plurality of financial institutions can cooperate together or compete with each other to finance the transactions taking place in the electronic corporate products trading marketplace 42.

As noted above, it is preferred that an incentive be provided to the company to earn consumption points as soon as possible. One possible incentive is the accrual of interest on the outstanding consumption point balances as described above. However, any desirable incentive can be provided. For example, a company can be considered to have fulfilled its obligation if it earns 95% of the required consumption points within a three month period. This will make sense if the company 6 or trading house 4 paid a sufficiently high transactional fee to the financial institution 8 upon entering into the transaction. Additionally, bonus points can be provided for early satisfaction of the consumption point obligation. These bonus points can be redeemed by the company for free products or services or, alternatively, applied to future consumption point obligations upon the sale of future UPA's.

The present invention advantageously provides a comprehensive network-based facility offering a variety of participants in the product chain to engage in transactions with each other using, e.g., a simple web browser interface. A plurality of users can simultaneously log into the marketplace 42 to buy and sell assets. By web enabling electronic corporate products trading marketplace 42, all users are afforded twenty-four hour per day availability. Companies and suppliers can study the market at their convenience and receive relatively easy to find, comprehensive asset information.

The concept of consumption points is a generic one. Each point has a monetary value. Therefore, the obligation of the company to earn points can be expressed in terms of any monetary value such as dollars or other currency. The points earned upon purchasing an asset can similarly be expressed in terms of money. The term “consumption point” is intended to refer to any measurement, whatever nomenclature is used, which is representative of a monetary value.

The term “company” is used in the generic sense and includes any legal entity including a person, a corporation, a partnership, a non-profit institution or other legal entity.

In the preferred embodiment, one or more financial institutions finance the cash and/or asset payment made to the company at the beginning of each transaction. However, the trading house can itself finance the transaction and carry out the various functions of the financial institution described above.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

In the claims:

1. A method for permitting a company to sell UPA's, said method comprising:
transferring UPA's from said company to a second party in return for a cash and/or asset payment;
said company obligating itself to earn a variable number of consumption points over an agreed to consumption period by making future purchases of assets, each purchase having a number of consumption points associated therewith.

2. The method according to claim 1, wherein said company makes future purchases of said assets during said consumption period so as to at least partially satisfy said obligation.

3. The method according to claim 1, wherein said number of consumption points is known to said company before said company makes said purchases.

4. The method according to claim 1, wherein said number consumption points to be earned varies as a function of an interest rate.

5. The method according to claim 1, further comprising periodically applying said interest rate.

6. The method according to claim 4, wherein said interest rate varies over said consumption period.

7. The method according to claim 6, wherein said interest rate increases over said consumption period.

8. The method according to claim 7, wherein said consumption period is divided into a plurality of sub-periods, said interest rate being constant within any given sub-period but varying from sub-period to sub-period.

9. The method according to claim 1, wherein said future purchases are made from said second party.

10. The method according to claim 1, wherein said future purchases are made from a third party.

11. The method according to claim 1, wherein some of said future purchases are made from said second party and other of said future purchases are made from a third party.

12. The method according to claim 9, wherein said second party is a trading house which sells a limited number of categories of assets.

13. The method according to claim 12, wherein said company and said trading house agree to limits on the price at which said trading house can offer to sell said assets to said company.

14. The method according to claim 13, wherein said limits are related to the amount of money said company would have to pay if it purchased said assets independently of said trading house.

15. The method according to claim 14, wherein said limits are set at the beginning of said consumption period but are periodically changed during said consumption period.

16. The method according to claim 15, wherein said limits are changed upon receipt of proof from said company of it ability to purchase one or more of said assets independently of said trading house at prices different than those originally agreed to.

17. The method according to claim 13, wherein said trading house sets the number of points associated with said sale of each said asset.

18. The method according to claim 17, wherein said trading house and said company agree to minimum limits on the number of points it will offer to award the company in connection with each said sale of each said asset.

19. The method according to claim 18, wherein said minimum limits are expressed as a percentage of the price for each asset offered for sale to said company by said trading house.

20. The method according to claim 19, wherein said minimum limits are calculated as a function of the average percentage of the price for each asset offered for sale to said company by said trading house.

21. The method according to claim 20, wherein said minimum limits are expressed in terms of a respective minimum limit for each said category of assets offered for sale to said company by said trading house.

22. The method according to claim 1, wherein said company makes cash payments during said consumption period, but prior to the end of said consumption period, to partially satisfy said obligation.

23. The method according to claim 13, wherein insurance is obtained to protect said company in the event said trading house fails to meet its obligation to offer said assets to said company at said agreed to price.

24. The method according to claim 18, wherein insurance is obtained to protect said company in the event that said trading house fails to meet its obligation to offer at least said minimum number of points in connection with said sale of each said asset.

25. The method according to claim 1, further including providing an incentive to said company to fulfill its obligation to earn consumption points prior to the end of said consumption period.

26. A method for permitting a company to sell UPA's, said method comprising:
transferring UPA's from said company to a second party in return for a cash payment from a financial institution;
said company obligating itself to earn a variablenumber of consumption points over an agreed to consumption period by making future purchases of assets, each purchase having a number of consumption points associated therewith;
said financial institution receiving a percentage of each purchase of said assets during said consumption period.

27. The method according to claim 26, wherein said company makes future purchases of said assets during said consumption period so as to at least partially satisfy said obligation.

28. The method according to claim 26, wherein said number of consumption points is known to said company before said company makes said purchases.

29. The method according to claim 26, wherein said number of consumption points to be earned varies as a function of an interest rate.

30. The method according to claim 29, further comprising periodically applying said interest rate.

31. The method according to claim 29, wherein said interest rate varies over said consumption period.

32. The method according to claim 31, wherein said interest rate increases over said consumption period.

33. The method according to claim 32, wherein said consumption period is divided into a plurality of sub-periods, the interest rate being constant within any given sub-period but increasing from sub-period to sub-period.

34. The method according to claim 26, wherein said future purchases are made from said second party.

35. The method according to claim 26, wherein said future purchases are made from a third party.

36. The method according to claim 26, wherein some of said future purchases are made from said second party and other of said future purchases are made from a third party.

37. The method according to claim 34, wherein said second party is a trading house which sells a limited number of categories of assets.

38. The method according to claim 37, wherein said company and said trading house agree to limits on the price at which said trading house can offer to sell said assets to said company.

39. The method according to claim 38, wherein said limits are related to the amount of money said company would have to pay if it purchased said assets independently of said trading house.

40. The method according to claim 39, wherein said limits are set at the beginning of said consumption period but are periodically changed during said consumption period.

41. The method according to claim 40, wherein said limits are changed upon receipt of proof from said company of it ability to purchase one or more of said assets independently of said trading house at prices different than those originally agreed to.

42. The method according to claim 38, wherein said trading house sets the number of points associated with said sale of each said asset.

43. The method according to claim 42, wherein said trading house and said company agree to minimum limits on the number of points it will offer to award the company in connection with each said sale of each said asset.

44. The method according to claim 43, wherein said minimum limits are expressed as a percentage of the price for each asset offered for sale to said company by said trading house.

45. The method according to claim 44, wherein said minimum limits are calculated as a function of the average percentage of the price for each asset offered for sale to said company by said trading house.

46. The method according to claim 45, wherein said minimum limits are expressed in terms of a respective minimum limit for each said category of assets offered for sale to said company by said trading house.

47. The method according to claim 26, wherein said company makes cash payments during said consumption period, but prior to the end of said consumption period, to partially satisfy said obligation.

48. The method according to claim 38, wherein insurance is obtained to protect said company in the event said trading house fails to meet its obligation to offer said assets to said company at said agreed to price.

49. The method according to claim 42, wherein insurance is obtained to protect said company in the event that said trading house fails to meet its obligation to offer at least said minimum number of points in connection with said sale of each said asset.

50. The method of claim 37, wherein said company purchases said assets from said trading house and makes a payment to said trading house for each such purchase equal to a selling price for said assets and said company pays a portion of said selling price, corresponding to the number of consumption points awarded for said purchase, to said financial institution.

51. The method of claim 37, wherein said company purchases said assets from said trading house and makes a partial payment of a selling price of said assets to said financial institution and a partial payment of said selling price of said assets to said financial institution, said partial payment to said financial institution corresponding to said number of consumption points awarded for said purchase, said partial payment to said trading house corresponding to the remainder of said selling price.

52. The method of claim 37, wherein said company purchases said assets from said trading house and makes a payment to a third party for each such purchase, said payment being equal to a selling price for said assets, said third party paying a portion of said selling price, corresponding to said number of consumption points awarded for said purchase, to said financial institution and paying the remainder of said payment to said trading house.

53. The method of claim 26, further including providing said company with an incentive to fulfill its obligation to earn consumption points prior to the end of said consumption period.

54. An electronic marketplace enabling companies to enter into deals for the sale of their UPA's, each deal involving at least a company and a UPA buyer and including the sale of UPA's by said company to said UPA buyer, a cash and/or asset payment to said company and an obligation on the part of said company to purchase future assets to fulfill an agreed to consumption point obligation, said system comprising:
a marketplace administration system connected to a communication network;
a plurality of user terminals connected to said communication network whereby a plurality of companies and one or more UPA buyers can communicate with said marketplace administration system over said communication network;
said marketplace administration system presenting a plurality of trading sites to at least some users of said user terminals, said user sites including:
one or more UPA trading sites at which said companies can offer to sell their UPA's to one or more of said UPA buyers, whereby deals can be entered into between said companies and said UPA buyers and relevant parameters of said deals can be entered into said market administration system; and
one or more sales sites at which said companies can purchase said assets, said sales sites providing an indication of both the price of each said asset and the number of consumption points to be awarded upon the purchase of each said asset;
said marketplace administration system keeping track of said deals and said outstanding balance of consumption points for each said deal.

55. The electronic marketplace according to claim 54, wherein a deal is entered into between a first of said companies and a first of said UPA buyers and wherein said one of said first company earns consumption points by purchasing assets from said first UPA buyer.

56. The electronic marketplace according to claim 55, wherein said user sites further include one or more sales sites at which UPA's purchased by one or more UPA buyers can be resold to third parties.

57. The electronic marketplace according to claim 56, wherein at least one of said UPA sales sites offers UPA's purchased by more than one of said UPA buyers.

58. The electronic marketplace according to claim 56, wherein said UPA's are sold on at least one of said UPA sales sites using an auction system.

59. The electronic marketplace according to claim 56, wherein certain potential purchasers of said UPA's are restricted from purchasing said UPA's.

60. The electronic marketplace according to claim 59, wherein said restrictions are based on the specific identity of said potential purchasers of said UPA's.

61. The electronic marketplace according to claim 59, wherein said restrictions are based upon a class of potential purchasers of said UPA's.

62. The electronic marketplace according to claim 59, wherein said restriction is based upon the geographic location of a potential purchaser of said UPA's.

63. The electronic marketplace according to claim 56, wherein said marketplace administration system stores financial information concerning each said company.

64. The electronic marketplace according to claim 54, wherein said companies can purchase assets from both said UPA buyer and from third parties on said one or more sales sites.

65. The electronic marketplace according to claim 64, wherein, for each said deal, said outstanding balance of consumption points is determined as a function of a number of consumption points earned by said company which is a party to said deal and a periodically charged interest rate.

66. The electronic trading system according to claim 54, wherein, for at least one of said deals, said party to said deal obligates itself to earn a variable number of consumption points over an agreed to consumption period by making future purchases of said assets, the number of consumption points to be earned varying as a function of a periodically applied interest rate.

67. The method according to claim 66, wherein said periodically applied interest rate varies over said consumption period.

68. The electronic marketplace according to claim 66, wherein said periodically applied interest rate increases over said consumption period.

69. The electronic marketplace according to claim 68, wherein said consumption period is divided into a plurality of sub-periods, the interest rate being constant within any given sub-period but increasing from sub-period to sub-period.

70. The electronic marketplace according to claim 54, wherein said UPA buyer is a trading house which sells a limited number of categories of assets.

71. The electronic marketplace according to claim 70, wherein, as part of at least one said deal, said company and said trading house agree to limits on the price at which said trading house can offer to sell said assets to said company.

72. The electronic marketplace according to claim 71, wherein said limits are related to the amount of money said company would have to pay if it purchased said assets independently of said trading house.

73. The electronic marketplace according to claim 72, wherein said limits are set at the beginning of said consumption period for said deal but are periodically changed during said consumption period.

74. The electronic marketplace according to claim 73, wherein said limits are changed upon receipt of proof from said company of it ability to purchase one or more of said assets independently of said trading house at prices different than those originally agreed to.

75. The electronic marketplace according to claim 70, wherein, as part of at least one of said deals, said trading house sets the number of points associated with each future sale of each said asset.

76. The electronic marketplace according to claim 75, wherein said trading house and said company agree to minimum limits on the number of points it will offer to award the company in connection with each said sale of each said asset.

77. The electronic marketplace according to claim 76, wherein said minimum limits are expressed as a percentage of the price for each asset offered for sale to said company by said trading house.

78. The electronic marketplace according to claim 77, wherein said minimum limits are calculated as a function of an average percentage of the price for each asset offered for sale to said company by said trading house.

79. The electronic marketplace according to claim 78, wherein said minimum limits are expressed in terms of a respective minimum limit for each said category of assets offered for sale to said company by said trading house.

80. The electronic marketplace according to claim 54, wherein, with respect to at least one said deal, said company makes a cash payment during said consumption period, but prior to the end of said consumption period, to partially satisfy said obligation.

81. The electronic marketplace according to claim 71, wherein insurance is obtained to protect said company in the event said trading house fails to meet its obligation to offer said assets to said company at prices which fall within said agreed to limits.

82. The electronic marketplace according to claim 76, wherein insurance is obtained to protect said company in the event that said trading house fails to meet its obligation to offer at least said minimum number of points in connection with said sale of each said asset.

83. The electronic marketplace according to claim 54, wherein said communication network is a world wide communication network.

84. The electronic marketplace according to claim 54, wherein said communication network is the Internet.

85. An electronic marketplace enabling companies to enter into deals with at least UPA buyers and financial institutions for the sale of their UPA's, each deal including the sale of UPA's by said company, a cash and/or asset payment to said company and an obligation on the part of said company to purchase future assets to fulfill an agreed to consumption point obligation, said system comprising:
a marketplace administration system connected to a communication network;
a plurality of user terminals connected to said communication network whereby a plurality of companies and one or more UPA buyers can communicate with said marketplace administration system over said communication network;
said marketplace administration system presenting a plurality of trading sites to at least some users of said user terminals, said user sites including:
one or more UPA trading sites accessible to said companies, said financial institution and said UPA buyers and at which said companies can offer to sell their UPA's to one or more of said UPA buyers, the deal being financed by said financial institution, whereby deals can be entered into between said companies, said financial institution and said UPA buyers and relevant parameters of said deals can be entered into said market administration system; and
one or more sales sites at which said companies can purchase said assets, said sales sites providing an indication of both the price of each said asset and the number of consumption points to be awarded upon the purchase of each said asset;
said marketplace administration system keeping track of said deals and said outstanding balance of consumption points for each said deal.

86. The electronic marketplace according to claim 85, wherein a deal is entered into between a first said company, a first said UPA buyer and said financial institution and wherein said first company earns consumption points by purchasing assets from said first UPA buyer, and makes a payment for such assets, part of said payment going to said financial institution, part of said payment going to said UPA buyer.

87. The electronic marketplace according to claim 86, wherein said user sites further include one or more sales sites at which UPA's purchased by one or more of said UPA buyers can be resold to third parties.

88. The electronic marketplace according to claim 87, wherein at least one of said UPA sales sites offers UPA's purchased by more than one of said UPA buyers.

89. The electronic marketplace according to claim 87, wherein said UPA's are sold on at least one of said UPA sales sites using an auction system.

90. The electronic marketplace according to claim 87, wherein certain potential purchasers of said UPA's are restricted from purchasing said UPA's.

91. The electronic marketplace according to claim 90, wherein said restrictions are based on the specific identity of said potential purchasers of said UPA's.

92. The electronic marketplace according to claim 90, wherein said restrictions are based upon a class of potential purchasers of said UPA's.

93. The electronic marketplace according to claim 90, wherein said restriction is based upon the geographic location of a potential purchaser of said UPA's.

94. The electronic marketplace according to claim 85, wherein said marketplace administration system stores financial information concerning each said company.

95. The electronic marketplace according to claim 85, wherein said companies can purchase assets from both said UPA buyer and from third parties on said one or more sales sites.

96. The electronic marketplace according to claim 85, wherein, for each said deal, said outstanding balance of consumption points is determined as a function of the number of consumption points earned by said company which is a party to said deal and a periodically charged interest rate.

97. The electronic trading system according to claim 85, wherein, for at least one of said deals, said party to said deal obligates itself to earn a variable number of consumption points over an agreed to consumption period by making future purchases of said assets, the number of consumption points to be earned varying as a function of a periodically applied interest rate.

98. The method according to claim 97, wherein said periodically applied interest rate varies over said consumption period for such deal.

99. The electronic marketplace according to claim 98, wherein said periodically applied interest rate increases over said consumption period.

100. The electronic marketplace according to claim 99, wherein said consumption period is divided into a plurality of sub-periods, said interest rate being constant within any given sub-period but increasing from sub-period to sub-period.

101. The electronic marketplace according to claim 85, wherein said UPA buyer is a trading house which sells a limited number of categories of assets.

102. The electronic marketplace according to claim 101, wherein, as part of at least one said deal, said company and said trading house agree to limits on the price at which said trading house can offer to sell said assets to said company.

103. The electronic marketplace according to claim 102, wherein said limits are related to the amount of money said company would have to pay if it purchased said assets independently of said trading house.

104. The electronic marketplace according to claim 103, wherein said limits are set at the beginning of said consumption period for said deal but are periodically changed during said consumption period.

105. The electronic marketplace according to claim 104, wherein said limits are changed upon receipt of proof from said company of its ability to purchase one or more of said assets independently of said trading house at prices different than those originally agreed to.

106. The electronic marketplace according to claim 101, wherein, as part of at least one of said deals, said trading house sets the number of points associated with said sale of each said asset.

107. The electronic marketplace according to claim 106, wherein said trading house and said company agree to minimum limits on the number of points it will offer to award the company in connection with each said sale of each said asset.

108. The electronic marketplace according to claim 107, wherein said minimum limits are expressed as a percentage of the price for each asset offered for sale to said company by said trading house.

109. The electronic marketplace according to claim 108, wherein said minimum limits are calculated as a function of an average percentage of the price for each asset offered for sale to said company by said trading house.

110. The electronic marketplace according to claim 109, wherein said minimum limits are expressed in terms of a respective minimum limit for each said category of assets offered for sale to said company by said trading house.

111. The electronic marketplace according to claim 85, wherein, with respect to at least one said deal, said company makes a cash payment during said consumption period, but prior to the end of said consumption period, to partially satisfy said obligation.

112. The electronic marketplace according to claim 102, wherein insurance is obtained to protect said company in the event said trading house fails to meet its obligation to offer said assets to said company at prices which fall within said limits.

113. The electronic marketplace according to claim 107, wherein insurance is obtained to protect said company in the event that said trading house fails to meet its obligation to offer at least said minimum number of points in connection with said sale of each said asset.

114. A method for permitting a company to sell UPA's, said method comprising:
transferring UPA's from said company to a second party in return for a cash and/or asset payment;
said company obligating itself to make future purchases of assets, wherein the amount of future purchases is variable.

115. The method according to claim 114 wherein said company earns a number of consumption points by making said future purchases.

116. The method according to claim 114, wherein said company agrees to make said future purchases over an agreed to consumption period.

117. The method according to claim 115, wherein said number of consumption points is known to said company before said company makes said purchases.
